(19) United States
(12) Patent Application Publication
(10) Pub. No.: US 2011/0086537 A1
(43) Pub. Date: Apr. 14, 2011

(54) CABLE ASSEMBLY WITH A DETACHABLE POSITIONING MECHANISM

(75) Inventors: PING-SHENG SU, Tu-Cheng (TW); HONG-LEI FAN, Kunshan (CN)

(73) Assignee: HON HAI PRECISION INDUSTRY CO., LTD., Tu-Cheng (TW)

(21) Appl. No.: 12/902,160

(22) Filed: Oct. 12, 2010

(30) Foreign Application Priority Data
Oct. 14, 2009 (CN) 200920219069.8

(51) Int. Cl. H01R 13/64

(52) U.S. Cl. 439/374

(57) ABSTRACT

A cable assembly (100), comprises an insulative housing (1); a plurality of contacts (2) disposed in the housing; a cable (4) electrically connecting to the plurality of contacts; a cover (5) formed around a rear end of the housing and a connection region between the contacts and the cable; and a positioning mechanism (6) detachably connected to one lateral side of the housing.

### FIELD OF THE INVENTION

The present invention relates to a cable assembly, and more particularly to a cable assembly with a detachable positioning mechanism.

### DESCRIPTION OF PRIOR ART

Nowadays, cable assembly is needed to position with a panel in an inner room of a PC case. And the cable assembly is positioned with the panel along a transversal direction through a positioning mechanism formed on one side of the cable assembly.

U.S. Pat. No. 7,572,144 B2 issued to Wu on Aug. 11, 2009 discloses a connector for mounting to a panel. The connector defines an insulative housing and a plurality of contacts disposed in the insulative housing. A retainer member is integrative formed on one side of the insulative housing. A slider member is assembled to the retainer member along a front to rear direction. A positioning mechanism is formed by the retainer member and the slider member. A front end of the slider member extends into an opening of the panel to make the connector engaged with the panel. However, sometimes, the opening of the panel does not has an enough space on one side thereof for the front end of the slider member extending thereinto. And, the opening of the panel has enough space on another side thereof for receiving the front end of the slider member. Thus, the connector can not mount to the panel. So, an insulative housing with a positioning mechanism formed on another side of the connector is needed to develop to meet the cooperation between the connector and the panel. However, the research and developing cost of the connector will be increased.

As discussed above, an improved cable assembly overcoming the shortages of existing technology is needed.

### SUMMARY OF THE INVENTION

Accordingly, an object of the present invention is to provide a cable assembly with a detachable positioning mechanism for mounting to a panel.

In order to achieve the above-mentioned objects, a cable assembly, comprises an insulative housing; a plurality of contacts disposed in the housing; a cable electrically connecting to the plurality of contacts; a cover formed around a rear end of the housing and a connection area between the contacts and the cable; and a positioning mechanism detachably connected to one lateral side of the housing.

Other objects, features and advantages of the invention will be apparent from the following detailed description taken in connection with the accompanying drawings.

### BRIEF DESCRIPTION OF THE DRAWINGS

FIG. 1 is a perspective view of a cable assembly in accordance with the present invention;

FIG. 2 is an exploded, perspective view of the cable assembly of FIG. 1;

FIG. 3 is similar to FIG. 2, but viewed from another aspect;

FIG. 4 is a partially assembled view of the cable assembly of FIG. 1;

FIG. 5 is similar to FIG. 4, but viewed from another aspect;

FIG. 6 is another partially assembled view of the cable assembly of FIG. 5.

### DETAILED DESCRIPTION OF PREFERRED EMBODIMENTS

Reference will now be made to the drawing figures to describe the present invention in detail.

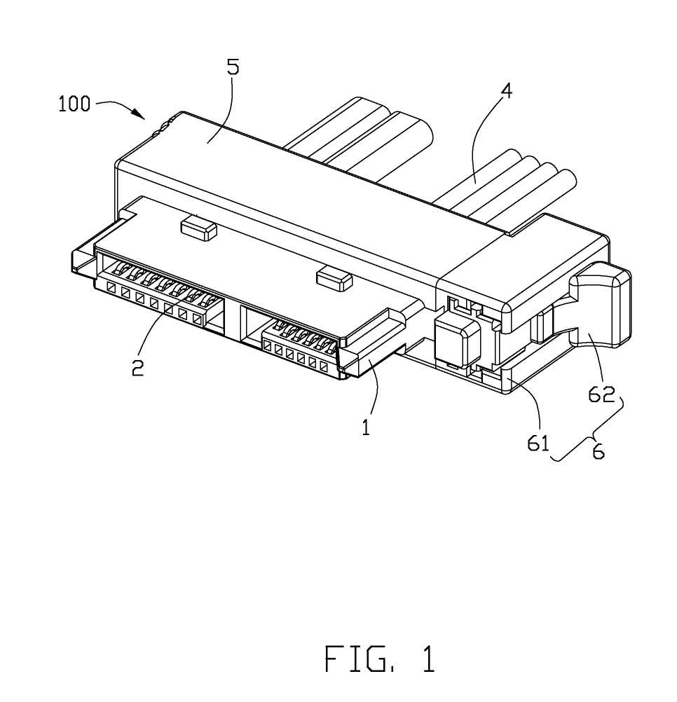

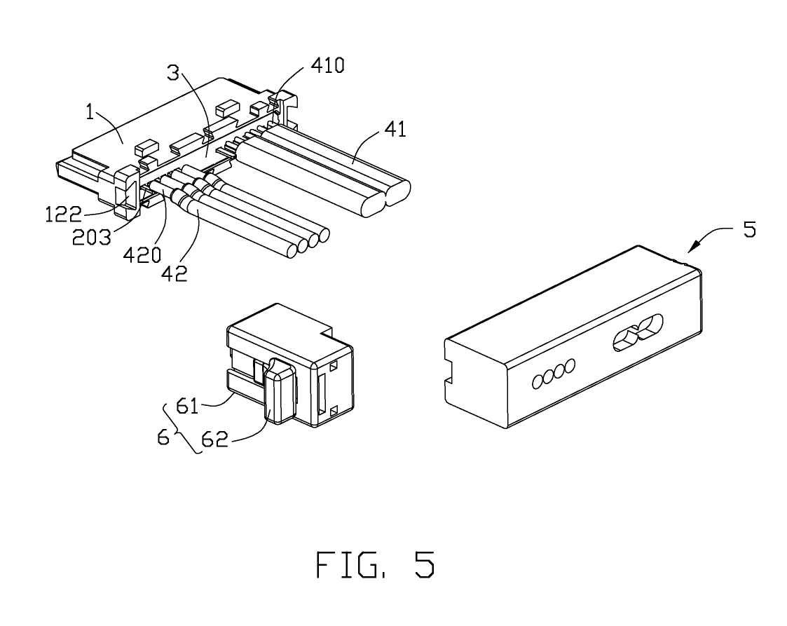

Referring to FIGS. 1 to 3 and 5, a cable assembly 100 in accordance with the present invention for mounting to a panel (not shown), comprises an insulative housing 1, a plurality of contacts 2 disposed in the insulative housing 1, a spacer 3 assembled to a rear end of the insulative housing 1 and allowing the plurality of contacts 2 pass through, a plurality of cables 4 electrically connected to the corresponding contacts 2 and a cover 5 formed on the rear end of the insulative housing 1. A detachable positioning mechanism 6 is connected to one side of the insulative housing 1 and interfered with the cover 5. And the positioning mechanism 6 comprises an engaging member 61 cooperated with the insulative housing 1 and a positioning member 62 assembled to the engaging member 61.

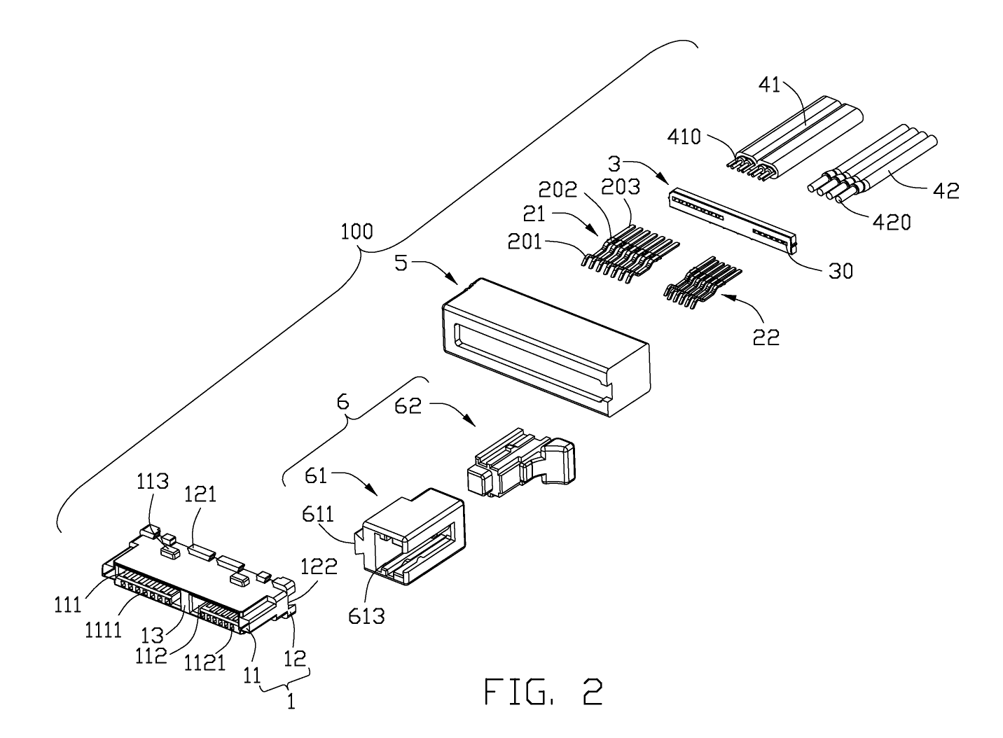

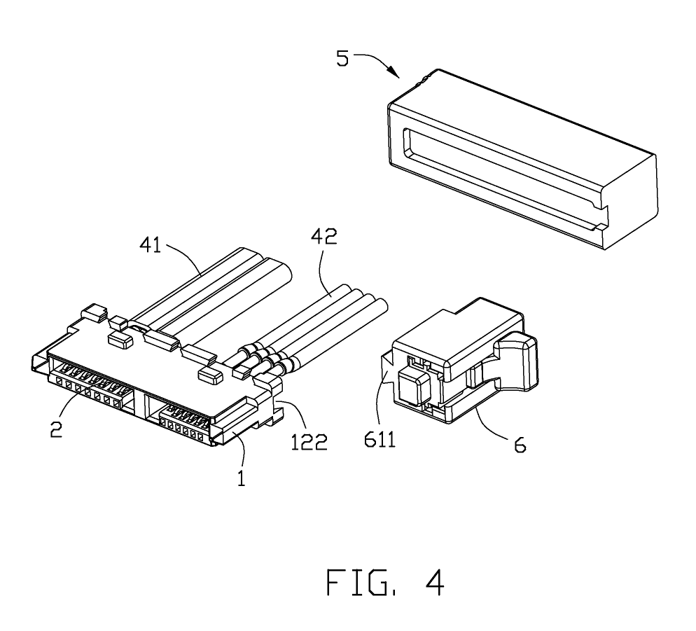

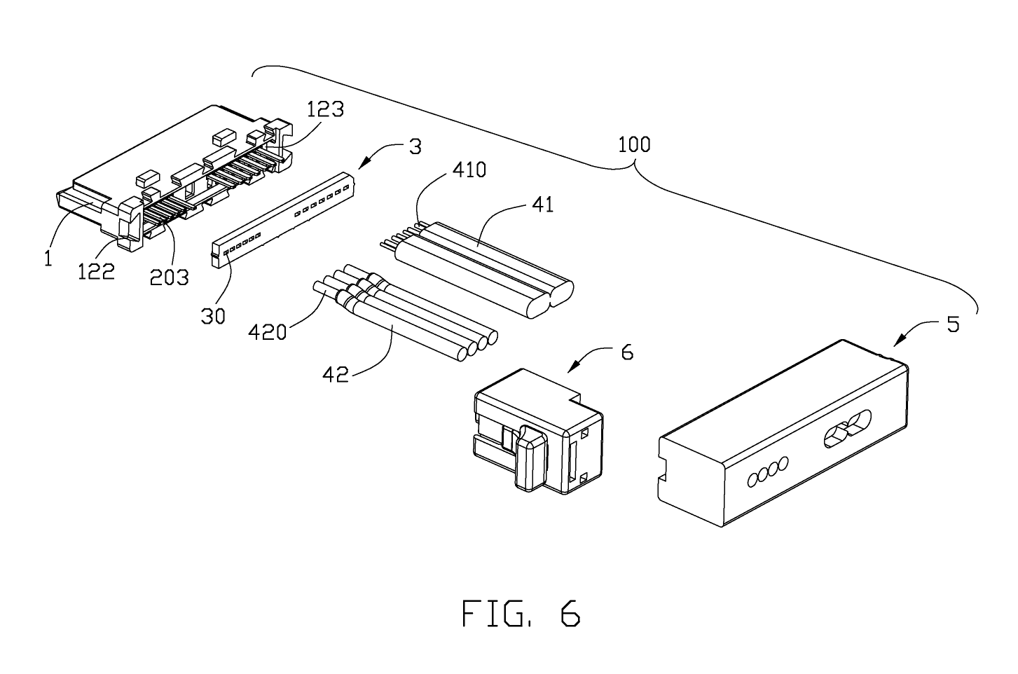

Referring to FIGS. 2 to 6, the insulative housing 1 comprises a mating portion 11 at a front section thereof and a coupling portion 12 at a rear section thereof. The mating portion 11 of the insulative housing 1 defines a mating surface 13. A first receiving room 111 and a second receiving room 112 are formed in the insulative housing 1 and spaced apart with each other along a transversal direction. The first and second receiving rooms 111, 112 extend rearward from a mating surface 13 for a distance. A plurality of first passageways 1111 are formed in an inner side of the first receiving room 111. A plurality of second passageways 1121 are also formed in an inner side of the second receiving room 112. Two spaced first keys 113 are formed on a top surface of the insulative housing 1. And two spaced second keys (not shown) are formed on a bottom surface of the insulative housing 1.

The coupling portion 12 of the insulative housing 1 defines a recess 123 formed on a rear surface of the insulative housing 1 for receiving the spacer 3. A plurality of protrusions 121 are respectively formed on two opposite surfaces of the coupling portion 12 of the insulative housing 1. Each protrusion 121 is in a shape of trapezium. The plurality of protrusions 121 can be cooperated and engaged with the cover 5. A pair of fixing portions 122 are respectively formed at two sides of the coupling portion 12 for connecting with the engaging member 61. In this embodiment, the fixing portion 122 is a trapeziform groove.

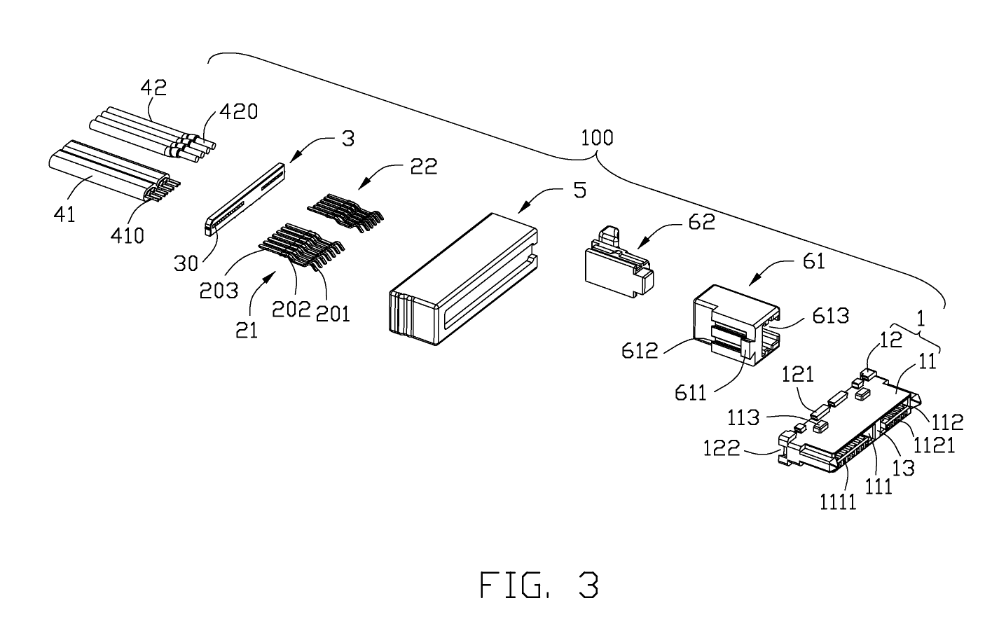

Referring to FIGS. 2 and 3, a plurality of contacts 2 are divided into a set of signal contacts 21 and a set of power contacts 22. The signal contacts 21 are all used for transmitting signal. The power contacts 22 are all used for transmitting power. Each contact 2 defines a retention section 202, a contacting section 201 extending forwardly from the retention section 202 and a soldering section 203 extending rearwardly from the retention section 202. Each contacting section 201 is crooked and elastic.

Referring to FIGS. 2, 3 and 5, the spacer 3 is elongated and is made of insulative material. A plurality of through-holes 30 are defined through the spacer 3 corresponding to the first and second passageways 1111, 1121 and allows the soldering section 203 of each contact 2 pass through the spacer 3 along a front to rear direction.

Referring to FIGS. 2 and 3, the cable 4 comprises a first cable 41 having a plurality of first conductors 410 therein and a second cable 42 having a plurality of conductor 420 therein. The first and second conductors 410, 420 can be electrically connected to the soldering sections 203 of the plurality of contacts 2.

Referring to FIGS. 3 to 5, the cover 5 is surrounded to the coupling portion 12 of the insulative housing 1 and a front end of the cable 4 through an overmolding process and engages with an inner side of the engaging member 61.

Referring to FIGS. 2, 3 and 5, the positioning mechanism 6 comprises an engaging member 61 connected to the fixing portion 122 of the insulative housing 1 and a positioning member 62 assembled to the engaging member 61 along a front to rear direction. The engaging member 61 defines a receiving space 613 extending rearward from a front surface thereof for a distance. The positioning member 62 has a portion received into the receiving space 613 of the engaging member 61 and locked with the engaging member 61. The positioning member 62 is capable of moving along a front to rear direction when an outer force exerts on the positioning member 62. The engaging member 61 defines a protruding piece 611 received into the groove 122 of the insulative housing 1. The engaging member 61 further defines two paralleled channels 612 extending along a front to rear direction for cooperating with the cover 5. In another embodiment, the engaging member 61 does not need to cooperate with the cover 5. The protruding piece 611 and the groove 122 both have a cross section in a shape of trapezium.

Referring to FIGS. 1 to 6, the assembling process of the cable assembly 100 made in according to the present invention starts from assembling the plurality of contacts 2 to the insulative housing 1. The signal contacts 21 and power contacts 22 are respectively received into the first and second passageways 1111, 1121. The contacting sections 201 of the contacts 2 are located upon the first and second passageways 1111, 1121. The retention sections 202 of the contacts 2 are interfered with the first and second passageways 1111, 1121 to make the contacts 2 positioned in the insulative housing 1. The soldering sections 203 of the contacts extend rearward beyond the rear surface of the insulative housing 1.

After the contacts 2 are received into the insulative housing 1, then assembling the spacer 3 to the recess 123 of the insulative housing 1. And, the soldering sections 203 of the contacts 2 pass through the spacer 3 along a front to rear direction.

After the spacer 3 is assembled to the insulative housing 1, then assembling the positioning mechanism 6 to a lateral side of the insulative housing 1. And, the positioning mechanism 6 connects to the insulative housing 1 through a protruding piece 611 of the engaging member 61 received into the groove 122 of the insulative housing 1.

Finally, the cover 5 is formed to the coupling portion 12 of the rear end of insulative housing 1 and a connection area between the contacts 2 and the cables 4 through an overmolding process.

Obviously, the positioning mechanism 6 can be assembled to each lateral side of the insulative housing 1. And, the positioning mechanism 6 can be removed from one side of the insulative housing 1 and then assembled to another side of insulative housing 1. So, the cable assembly 100 can be mounted to the different types of panels in different environment. As a result, a housing having a new structure mounted to a different panel does not need to develop. Thus, the develop cost of the cable assembly 100 is lower, and the utilization of the insulative housing 1 of the cable assembly 100 is improved.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. A cable assembly, comprising:
an insulative housing;
a plurality of contacts disposed in the housing;
a cable electrically connecting to the plurality of contacts;
a cover formed around a rear end of the housing and a connection region between the contacts and the cables; and
a positioning mechanism detachably connected to one lateral side of the housing.

2. The cable assembly as recited in claim 1, wherein the positioning mechanism comprises an engaging member engaged with the housing and a positioning member disposed in the engaging member.

3. The cable assembly as recited in claim 2, wherein the engaging member defines a protruding piece received into a groove formed on a lateral side of the housing.

4. The cable assembly as recited in claim 2, wherein the housing defines a mating portion at a front end thereof and a coupling portion at a front end thereof, the groove formed on a side of the coupling portion.

5. The cable assembly as recited in claim 2, wherein the housing defines another groove for cooperating with the protruding piece of the engaging member.

6. The cable assembly as recited in claim 1, wherein the cable assembly further defines a spacer received into a recess formed on a rear surface of the housing.

7. The cable assembly as recited in claim 6, wherein each contact defines a soldering section passing through the spacer and beyond the rear surface of the housing.

8. The cable assembly as recited in claim 1, wherein the housing defines a plurality of passageways therein, each contact is received into a corresponding passageway.

9. The cable assembly as recited in claim 3, wherein the protruding piece and the groove both has a cross section in a shape of trapezium.

10. The cable assembly as recited in claim 1, wherein the cover is formed to the housing through an overmolding process and interfered with the positioning mechanism.

11. A cable assembly for mounting to a panel, comprising:
a housing having a mating portion and a coupling portion;
a plurality of contacts disposed in the housing;
a cable electrically connected with the contacts;
a cover cooperated with the coupling portion and surrounding a connection region between the contacts and the cable; and
a positioning mechanism detachably assembled to a lateral side of the housing and positioned with the cover.

12. The cable assembly as recited in claim 11, wherein the positioning mechanism is capable of connecting to another lateral side of the housing.

13. The cable assembly as recited in claim 11, wherein the positioning mechanism comprises an engaging member connected to the housing and a positioning member received in and positioned with the engaging member.

14. The cable assembly as recited in claim 13, wherein the positioning member is capable of moving along a front to rear direction.

15. The cable assembly as recited in claim 13, wherein the engaging member defines a protruding piece received into a groove formed on a lateral side of the housing along a front to rear direction.

16. A cable connector assembly for use with different-type panels each having an opening with at least one alignment keyway therein, comprising:
an insulative housing including a front mating portion and a rear coupling portion;
at least one key formed on an exterior face of the front mating portion;
a plurality of contacts disposed in the housing;
a plurality of wires located behind and electrically connecting to the corresponding contacts; and
a positioning mechanism discrete from the housing while intimately located by one lateral side of the housing; wherein
interengaging structures are respectively formed on the rear coupling portion and the positioning mechanism on said lateral side under condition that said positioning mechanism is optionally and selectively attached to said rear coupling portion on said lateral side while being unable to be withdrawn from the housing once a cover is applied to the housing and the wires for integration.

17. The cable connector assembly as claimed in claim 16, wherein said housing further defines another interengaging structure on the other lateral side similar to the interengaging structure on said lateral side so as to allow the positioning mechanism to be alternatively attached thereto for complying with another type panel.

18. The cable connector assembly as claimed in claim 16, wherein said cover is over-molded upon the housing and the corresponding wires.

19. The cable connector assembly as claimed in claim 16, wherein said interengaging structures are configured to only allow the positioning mechanism to be forwardly assembled to the rear coupling portion from a rear side of the housing under condition that the cover prevents said positioning mechanism from backward moving.

20. The cable connector assembly as claimed in claim 19, wherein said positioning mechanism includes an engaging member and a positioning member moveable relative to the engaging member at least in a front-to-back direction so that the engaging member is constantly positioned beside the rear coupling portion while the positioning member protrudes beyond the rear coupling portion in said front-to-back direction and essentially located beside the front mating portion when the connector is mounted to the corresponding panel.
